(19) United States
(12) Patent Application Publication
(10) Pub. No.: US 2003/0200472 A1
(43) Pub. Date: Oct. 23, 2003

(54) Computer and power supply controlling method

(75) Inventors: Makoto Midorikawa, Ome-shi (JP); Hideaki Muraya, Fuchu-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/418,122

(22) Filed: Apr. 18, 2003

(30) Foreign Application Priority Data
Apr. 22, 2002 (JP) 2002-119329

(51) Int. Cl. G06F 1/26

(52) U.S. Cl. 713/300

(57) ABSTRACT

A computer comprises a first terminal to which a motor driving voltage terminal of a disk drive can be connected, a second terminal to which a circuit operating voltage terminal of the disk drive can be connected, a first power line of a first voltage, and a second power line of a second voltage. The computer causes a power supply circuit which supplies the first voltage to the first terminal and one of the first voltage and the second voltage to the second terminal.

### CROSS-REFERENCE TO RELATED APPLICATIONS

This application is based upon and claims the benefit of priority from the prior Japanese Patent Application No. 2002-119329, filed Apr. 22, 2002, the entire contents of which are incorporated herein by reference.

### BACKGROUND OF THE INVENTION

1. Field of the Invention

This invention relates to a computer apparatus suitable for the configuration of an apparatus where, of a plurality of types of disk drives differing in the combination of logic operation proper supply voltage and motor driving proper supply voltage, or a plurality of types of disk drives differing in the possible operating voltage of part of the circuitry, any disk drive is connected to the circuit board of the body of the apparatus, and to a method of supporting the mounting of disk drives differing in power supply.

2. Description of the Related Art

In a conventional 2.5-inch hard disk drive (hereinafter, referred to as an HDD) used in a portable personal computer, the rated supply voltage for operating the internal logic circuit and the rated supply voltage for driving the motor were both 5 V. Hereinafter, the 2.5-inch HDD is referred to as the 5-V single power supply HDD. In recent years, in addition to the 5-V single power supply HDD, a 2.5-inch HDD (hereinafter, referred to as a multi-voltage HDD) using 5 V as the rated supply voltage for driving the motor and 3 V (precisely 3.3 V) as the proper supply voltage for operating the internal logic circuit and a 1.8-inch HDD using 3 V as both of the proper supply voltages for driving the motor and operating the internal logic circuit have come into use. Here, a combination of the proper supply voltage for operating the logic circuit and the proper supply voltage for driving the motor is referred to as a power supply type. The individual HDDs differing in the power supply type are connected to the circuit board of the body with a flexible cable and are all mounted in the same housing. Here, in the 2.5-inch HDD, the connector connections are standardized for each power supply type (5-V single power supply HDD/multi-voltage HDD). Consequently, the internal logic circuit operating power supply is supplied from the same connector terminal on the circuit board.

As described above, in a small-size personal computer containing a plurality of types of HDDs differing in power supply type, a body board was provided for each of the power supply types of the HDDs to be mounted (e.g., 5-V single power supply HDD/multi-voltage HDd/1.8-inch HDD) and the operating power supply was supplied to the mounted HDDs. In this case, although the multi-voltage HDD can be operated from the 5-V single power supply by setting the withstand voltage of the internal logic circuit of the multi-voltage HDD to 5 V or higher, this cannot be applied to a battery-powered small-size personal computer, because the power consumption increases.

As described above, in a conventional small-size personal computer, a body board was provided for each of the power supply types of the HDDs to be mounted (5-V single power supply HDD/multi-voltage HDD/1.8-inch HDD), causing a product cost problem and a product management problem. Moreover, the sharing of the body board by the 5-V single power supply HDD and multi-voltage HDD increased the power consumption when the multi-voltage HDD was mounted, causing the problem of preventing power saving.

### BRIEF SUMMARY OF THE INVENTION

According to an embodiment of the present invention, there is provided a computer comprises a first terminal to which a motor driving voltage terminal of a disk drive can be connected, a second terminal to which a circuit operating voltage terminal of the disk drive can be connected, a first power line of a first voltage, a second power line of a second voltage, and a power supply circuit which supplies the first voltage to the first terminal and one of the first voltage and the second voltage to the second terminal.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the configuration of a computer apparatus according to a first embodiment of the present invention;

FIG. 2 is a table to help explain the operation of the first embodiment;

FIG. 3 is a block diagram showing the configuration of a computer apparatus according to a second embodiment of the present invention;

FIG. 4 is a table to help explain the operation of the second embodiment;

FIG. 5 is a block diagram showing the configuration of a computer apparatus according to a third embodiment of the present invention; and

FIG. 6 is a flowchart for the procedure for processing in the third embodiment.

### DETAILED DESCRIPTION OF THE INVENTION

Hereinafter, referring to the accompanying drawings, embodiments of the present invention will be explained. In the embodiments, disk drives to be mounted (or to be subjected to power supply control) are assumed to be three power supply types of HDDs: a 5-V single power supply HDD, a 3-V/5-V multi-voltage HDD, and a 1.8-inch HDD. To be precise, the voltages of the HDD power supplies used in the embodiments are 5 V and 3.3 V. In an explanation of the embodiments, however, the power supply of 3.3 V is referred to as the power supply of 3 V for the sake of simplicity.

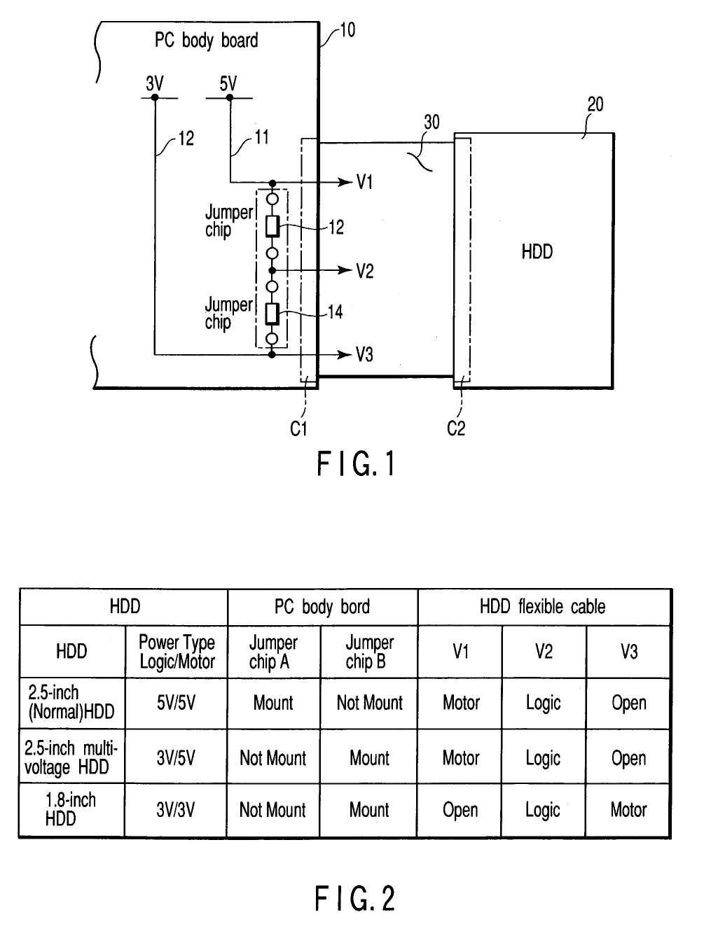

A first embodiment of the present invention will be explained by reference to FIGS. 1 and 2.

FIG. 1 is a block diagram showing the configuration of the main part of the first embodiment.

On a body board of a personal computer (hereinafter, referred to as a PC body board) 10, an HDD 20 is mounted via an HDD connecting interface. The HDD connecting interface is composed of a flexible cable 30, an HDD connecting connector C1 provided on the PC body board 10, and a connector C2 provided on the HDD 20. The HDD 20 is any one of the HDDs of the aforementioned power supply types (i.e., 5-V single power supply HDD/multi-voltage HDD/1.8-inch HDD).

On the PC body board 10, a power line 11 to which a 5-V power supply is supplied and a power line 12 to which a 3-V power supply is supplied are provided as HDD operating power lines. The 5-V power supply on the power line 11 is supplied to a motor driving power supply line V1 of the flexible cable 30 via the connector C1. The 3-V power supply on the power line 12 is supplied to a motor driving power supply line V3 of the flexible cable 30 via the connector C1.

Between the power line 11 and the power line 12, two short-circuit element mounting units 13, 14 are provided in series. The short-circuit element mounting units 13, 14 use jumper chips (A, B) as short-circuit elements, respectively. A short-circuit element (jumper chip A or jumper chip B) is mounted on either the short-circuit element mounting unit 13 or 14 according to the power supply type of the mounted HDD 20.

The 5-V or 3-V power supply output from the junction point of the two short-circuit element mounting units 13, 14 connected in series between the power line 11 and power line 12 is supplied to a logic circuit operating power supply line V2 of the flexible cable 30 as a logic circuit operating power supply for the mounted HDD 20.

FIG. 2 is a table to help explain the relationship between the power supply type of the mounted HDD and the mounting of a jumper chip (A, B) selectively mounted on either the short-circuit element mounting unit 13 or 14.

In the first embodiment, when the HDD 20 to be mounted is, for example, a 5-V single power supply HDD, a jumper chip A is mounted on the short-circuit element mounting unit 13 on the PC body board 10. When the jumper chip A is mounted, the 5-V power supply on the power line 11 is output to the logic operating power supply line V2 of the flexible cable 30 via the jumper chip A, with the result that the 5-V power supply is supplied to the logic circuit (HDC) of the mounted HDD 20. Therefore, a 5-V operating power supply suitable for the logic circuit of the HDD 20 is supplied to the logic circuit. When a 2.5-inch HDD is mounted, the 5-V power supply on the power line 11 is supplied to the motor driving power supply line V1 of the flexible cable 30 via the connector C1 and serves as a motor driving power supply for the mounted 2.5-inch HDD.

When the HDD 20 to be mounted is, for example, a multi-voltage HDD, a jumper chip B is mounted on the short-circuit element mounting unit 14 on the PC body board 10. This causes the 3-V power supply on the power line 12 to be output to the logic circuit operating power supply line V2 of the flexible cable 30 via the jumper chip B mounted on the short-circuit element mounting unit 14, with the result that the 3-V power supply is supplied to the logic circuit (HDC) of the mounted HDD 20. Therefore, a 3-V operating power supply suitable for the logic circuit of the HDD 20 is supplied to the logic circuit.

When the HDD 20 to be mounted is, for example, a 1.8-inch HDD, a jumper chip B is mounted on the short-circuit element mounting unit 14 on the PC body board 10. This causes the 3-V power supply on the power line 12 to be output to the logic circuit operating power supply line V2 of the flexible cable 30 via the jumper chip B mounted on the short-circuit element mounting unit 14, with the result that the 3-V power supply is supplied to the logic circuit (HDC) of the mounted HDD 20. Therefore, a 3-V operating power supply suitable for the logic circuit of the HDD 20 is supplied to the logic circuit. When a 1.8-inch HDD is mounted, the 3-V power supply on the power line 12 is supplied to the motor driving power supply line V3 of the flexible cable 30 via the connector C1 and serves as a motor driving power supply for the mounted 1.8-inch HDD.

As described above, with the first embodiment, the position where a short-circuit element (or jumper chip) is mounted is selected according to the power supply type of the mounted HDD, which makes it possible to supply a logic circuit operating power supply and motor driving power supply suitable for the mounted HDD and standardize the PC body board 10 for HDDs of various power supply types.

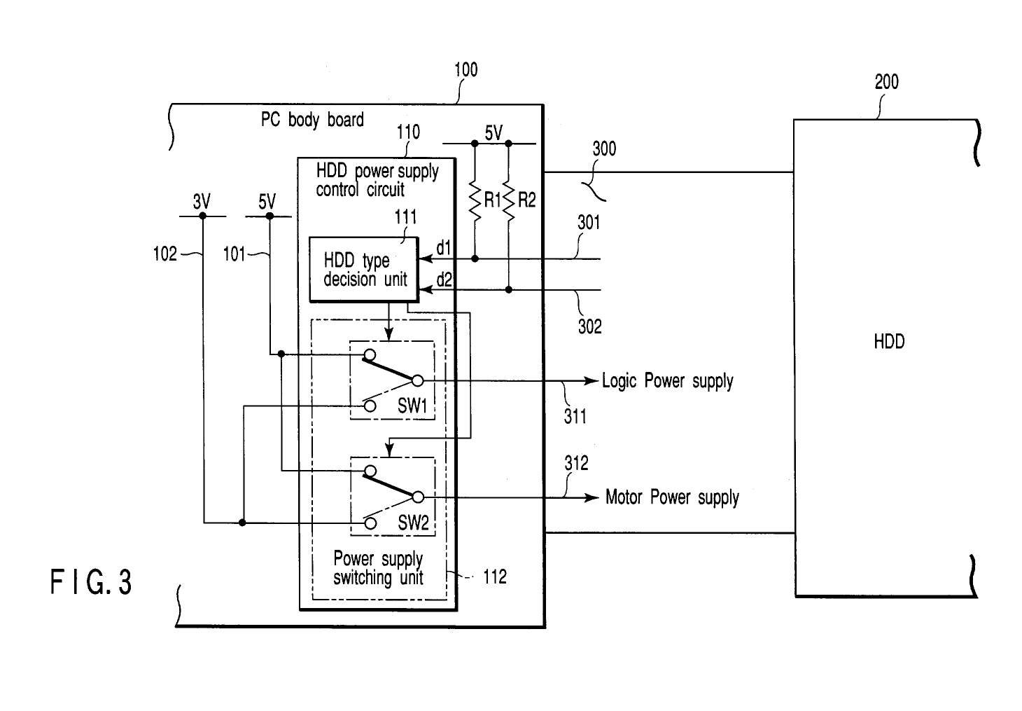

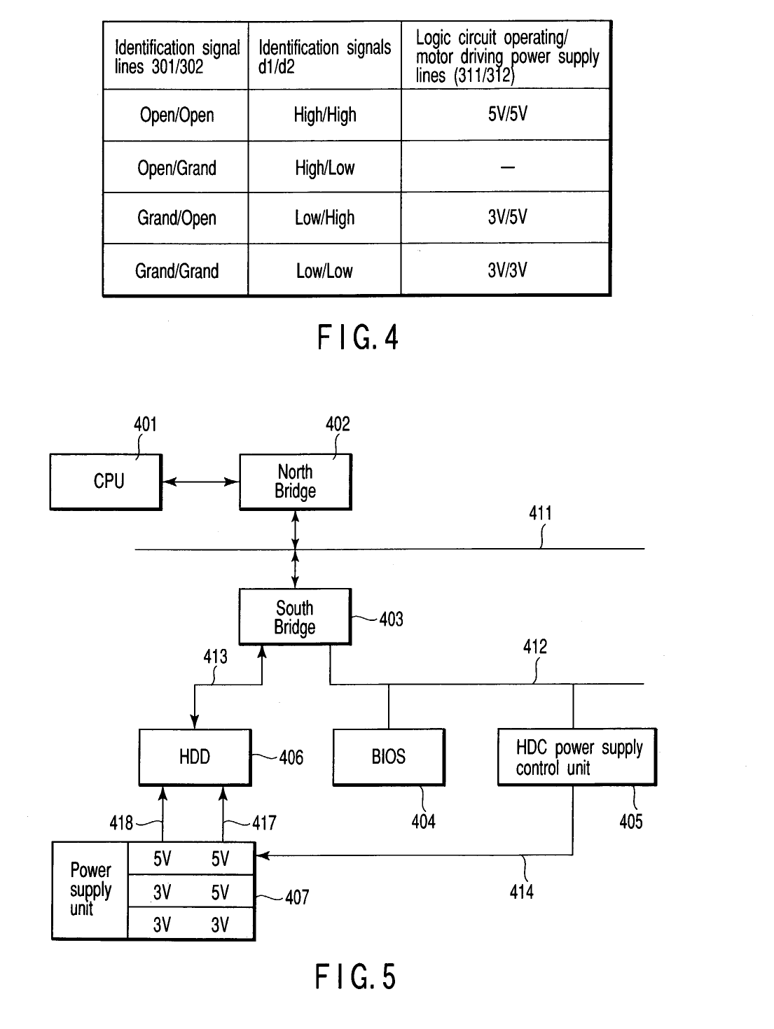

Hereinafter, a second embodiment of the present invention will be explained by reference to FIGS. 3 and 4.

FIG. 3 is a block diagram showing the configuration of the main part of the second embodiment.

An HDD 200 mounted on the body of a personal computer or of a computer apparatus is connected to the body board of the personal computer (hereinafter, referred to as the PC body board) 100 via an HDD connecting interface. The HDD connecting interface is composed of a flexible cable 300, an HDD connecting connector (not shown) provided on the PC body board 100, and a connector provided on the HDD 200. The HDD 200 mounted on the body of the apparatus is any one of the HDDs of the aforementioned power supply types (i.e., 5-V single power supply HDD/multi-voltage HDD/1.8-inch HDD).

On the PC body board 100, a power line 101 to which a 5-V power supply is supplied and a power line 102 to which a 3-V power supply is supplied are provided as HDD operating power lines. The 5-V power supply on the power line 101 and the 3-V power supply on the power line 102, which are selectively controlled by an HDD power supply control circuit 110 explained later, are supplied to the HDD 200 mounted on the body of the apparatus via the flexible cable 300.

Furthermore, on the PC body board 100, the HDD power supply control circuit 110 is provided. The HDD power supply control circuit 110 controls the supply of motor driving power and logic circuit operating power to the mounted HDD 200. The HDD power supply control circuit 110 includes an HDD type decision unit 111 to determine the power supply type of the HDD 200 and a power supply switching unit 112. The power supply switching unit 112 includes two selector switches SW1, SW2. The selector switch SW1 constitutes a select circuit for the logic circuit operating power supply and the selector switch SW2 constitutes a select circuit for the motor driving power supply.

The 5-V power supply on the power supply line 101 and the 3-V power supply on the power supply line 102 are supplied to the selector switches SW1, SW2 of the power supply switching unit 112 provided in the HDD power supply control circuit 110.

The selector switch SW1, which constitutes a select circuit for the logic circuit operating power supply, selects the 5-V power supply on the power supply line 101 or the 3-V power supply on the power supply line 102 as the logic circuit operating power supply under the control of the HDD type decision unit 111 and outputs the selected power supply to a logic circuit operating power supply line 311 of the flexible cable 300.

The selector switch SW2, which constitutes a select circuit for the motor driving power supply, selects the 5-V power supply on the power supply line 101 or the 3-V power supply on the power supply line 102 as the motor driving power supply under the control of the HDD type decision unit 111 and outputs the selected power supply to a motor driving power supply line 312 of the flexible cable 300.

Two predetermined signal lines of the flexible cable 300 are pulled up by resistances R1, R2 on the PC body board 100 side as HDD-type identification signal lines 301, 302. The identification signals (d1, d2) on the identification signal lines 301, 302 are input to the HDD type decision unit 11 provided in the HDD power supply control circuit 110.

On the basis of the values (High/Low) of the identification signals (d1, d2) on the identification signal lines 301, 302, the HDD type decision unit 111 determines which power supply type of HDD (5-V signal power supply HDD/multi-voltage HDD/1.8-inch HDD) the mounted HDD 200 is and, on the basis of the result of the determination, controls the switching of the switches SW1, SW2 in the power supply switching unit 112.

FIG. 4 is a table showing the relationship between the signal levels (Open/Ground) of the identification signal lines 301, 302, the values (High/Low) of the identification signals (d1, d2), and the supply voltages output to the logic circuit operating power line 311 and the motor driving power line 312.

In the second embodiment, when the 5-V single power supply HDD is mounted as the HDD 200, the identification signal lines 301, 302 on the flexible cable 300 are made open so that both of the identification signals (d1, d2) may be high. Furthermore, when the multi-voltage HDD is mounted as the HDD 200, the identification signal line 301 on the flexible cable 300 is set at the ground potential (Ground) so that only d1 of the identification signals (d1, d2) may be low. In addition, when the 1.8-inch HDD is mounted as the HDD 200, the identification signal lines 301, 302 on the flexible cable 300 are set to the ground potential (Ground) so that both of the identification signals (d1, d2) may be low. These settings can be done easily on the flexible cable 300 or on the HDD 200 side.

When both of the identification signals (d1, d2) on the identification signal lines 301, 302 are high, the HDD type decision unit 111 provided in the HDD power supply control circuit 110 performs switching control in such a manner that both of the selector switches SW1, SW2 in the power supply switching unit 112 select the 5-V power supply on the power line 101. This causes the 5-V motor driving power supply and 5-V logic circuit operating power supply suitable for the HDD 200 (or 5-V single power supply HDD) mounted on the body of the apparatus to be supplied to the logic circuit operating power line 311 and motor driving power line 312 of the flexible cable 300.

In addition, when only d1 of the identification signals (d1, d2) on the identification signal lines 301, 302 is low, the HDD type decision unit 111 performs switching control in such a manner that the selector switch SW1 of the power supply switching unit 112 selects the 3-V power supply on the power line 102 and the selector switch SW2 selects the 5-V power supply on the power line 101. This causes not only the 3-V logic circuit operating power supply suitable for the HDD 200 (or multi-voltage HDD) mounted on the body of the apparatus to be supplied to the logic circuit operating power line 311 of the flexible cable 300 and but also the 5-V motor driving power supply to be supplied to the motor driving power line 312.

Furthermore, when both of the identification signals (d1, d2) on the identification signal lines 301, 302 are low, the HDD type decision unit 111 performs switching control in such a manner that both of the selector switches SW1, SW2 in the power supply switching unit 112 select the 3-V power supply on the power line 102. This causes the 3-V motor driving power supply and 3-V logic circuit operating power supply suitable for the HDD 200 (or 1.8-inch HDD) mounted on the body of the apparatus to be supplied to the logic circuit operating power line 311 and motor driving power line 312 of the flexible cable 300.

As described above, with the second embodiment, just connecting the HDD 200 to the PC body board 100 via such a connecting interface as the flexible cable 300 enables the logic circuit operating power supply and motor driving power supply suitable for the power supply type of the mounted HDD 200 to be supplied to the HDD 200, which makes it possible to reduce the power consumption and standardize the PC body board for various types of HDDs to be mounted (i.e., 5-V single power supply HDD/multi-voltage HDD/1.8-inch HDD).

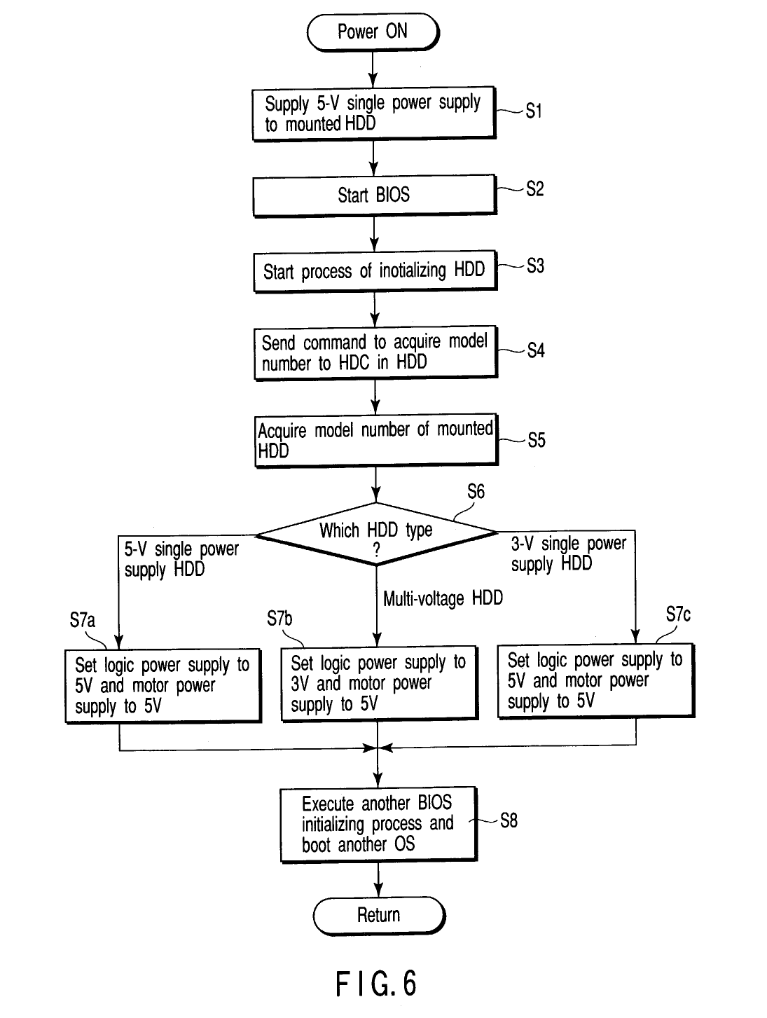

Next, a third embodiment of the present invention will be explained by reference to FIGS. 5 and 6.

FIG. 5 is a block diagram showing the main part of the third embodiment.

As shown in FIG. 5, a computer according to the third embodiment comprises a CPU 401, a north bridge 402, a south bridge 403, a BIOS-ROM 404, an HDC supply voltage control unit 405, an HDD 406, and a power supply unit 407.

The CPU 401, which supervises control of the entire system, executes the process of controlling the power supply to the mounted HDD shown in FIG. 6 on the basis of the initializing routine included in a control program (BIOS) stored in the BIOS-ROM 404 and supports the mounting in connecting various types of HDDs including a multi-voltage HDD.

The north bridge 402 is a bridge device that connects a local bus for the CPU 401 and a PCI bus 411 bidirectionally. The south bridge 403 is a bridge device that connects the PCI bus 411 and an ISA bus or an LPC bus 412 bidirectionally.

To the south bridge 403, an HDD 406 serving as external storage for this computer is connected via a special bus 413. In the third embodiment, any one of a 5-V single power supply HDD, a multi-voltage HDD, and a 1.8-inch HDD is mounted as the HDD 406.

The HDC supply voltage control unit 405, which receives a command from the CPU 401, controls the power supply unit 407 via a control signal line 414. According to the control signal received from the HDC supply voltage control unit 405 via the control signal line 414, the power supply unit 407 supplies the motor driving power supply and logic circuit operating power supply to the mounted HDD 406 via a motor driving power supply line 417 and a logic circuit operating power supply line 418.

Here, the process of controlling the power supply to the mounted HDD in the third embodiment will be explained by reference to a flowchart shown in FIG. 6.

When the system power supply is turned on, the CPU 401 executes the initializing process of FIG. 6 according to the control program (BIOS) stored in the BIOS-ROM 404. At this time, the turning on of the power supply causes the 5-V motor driving power supply and logic circuit operating power supply to be supplied to the mounted HDD 406 as an initial operating power supply (step S1).

In the initializing process carried out according to the BIOS, the CPU 401 sends a command to acquire a model number to the logic circuit (HDC) in the mounted HDD 406 via the special bus 413 (steps S2 to S4) and acquires the model number (or identification information) from the HDC in the mounted HDD 406 (step S5). The CPU 401 determines the power supply type of the mounted HDD 406 from the model number acquired from the HDC (step S6).

Determining that the mounted HDD 406 is a 5-V single power supply HDD, the CPU 401 will send command A to set the logic circuit operating power supply to 5 V and the motor driving power supply to 5 V to the HDC supply voltage control unit 405 (step S7a). Moreover, determining that the mounted HDD 406 is a multi-voltage HDD, the CPU 401 will send command B to set the logic circuit operating power supply to 3 V and the motor driving power supply to 5 V to the HDC supply voltage control unit 405 (step S7b). In addition, determining that the mounted HDD 406 is a 1.8-inch HDD, the CPU 401 will send command C to set the logic circuit operating power supply to 3 V and the motor driving power supply to 3 V to the HDC supply voltage control unit 405 (step S7c).

Receiving the command from the CPU 401, the HDC supply voltage control unit 405 controls the power supply unit 407 and supplies the motor driving power supply and logic circuit operating power supply at the proper voltage to the mounted HDD 406 via the motor driving power supply line 417 and logic circuit operating power supply line 418. Specifically, receiving command A from the CPU 401, the HDC supply voltage control unit 405 controls the power supply unit 407 and outputs the 5-V power supply to each of the motor driving power supply line 417 and logic circuit operating power supply line 418. In addition, receiving command B, the HDC supply voltage control unit 405 outputs the 5-V power supply to the motor driving power supply line 417 and the 3-V power supply to the logic circuit operating power supply line 418. Moreover, receiving command C, the HDC supply voltage control unit 405 outputs the 3-V power supply to each of the motor driving power supply line 417 and the logic circuit operating power supply line 418.

Thereafter, the CPU 401 executes another BIOS initializing process and loads another OS (operating system) (step S8).

As descried above, in the third embodiment, the simple hardware configuration enables the logic circuit operating power supply and motor driving power supply suitable for the power supply type of the mounted HDD 406 to be supplied to the mounted HDD 406, which makes it possible to reduce the power consumption and standardize the PC body board for various types of HDDs to be mounted (i.e., a 5-V single power supply HDD, a multi-voltage HDD, and a 1.8-inch HDD).

Although in the third embodiment, the logic circuit of the multi-voltage HDD, the logic circuit of the 1.8-inch HDD logic circuit, and the motor have been designed to withstand 5 V and been put into the initial operation, other approaches may be used. For instance, the following control may be added: as the initial power supply, the voltage of the logic circuit operating power supply is set to an operating voltage close to the threshold voltage of the logic circuit (HDC) built into the multi-voltage HDD. When there is no normal response in monitoring the response of the command, control is performed to step up the logic circuit operating power supply.

Although in the above embodiments, three power supply types of HDDs, the 5-V single power supply HDD, 3-V/5-V multi-voltage HDD, and 3-V single power supply 1.8-inch HDD, have been subjected to power supply control, the present invention is not limited to this. For instance, a 5-V single power supply 2.5-inch HDD and a 3-V/5-V multi-voltage HDD may be subjected to power supply control. Alternatively, various types of disk drives, including an HDD requiring a plurality of power supplies other than the aforementioned HDDs, a DVD-RAM, a magneto-optical disk drive, and a floppy disk drive, may be subjected to power supply control. Furthermore, the present invention may be applied to a system in which a plurality of types of disk drives differing in the storage medium or the driving method are mounted, a system in which the above-described disk drives and other large-capacity disk drives are mounted, and a system in which any one of a plurality of disk drives differing in the operating voltage of the driving section is mounted.

Furthermore, a computer may be so configured that three or more kinds of logic circuit operating supply voltages and three or more kinds of motor driving supply voltages are combined so as to enable disk drives of a plurality of power supply types to be connected. In this case, the computer body is designed to provide power supplies with three or more kinds of voltages according to the kinds of power supply types. In the configuration of the first embodiment, a short-circuit element mounting unit for connecting a power line to supply a power supply according to the power supply type of the disk drive is provided for each of the motor driving power supply line and the logic circuit operating power supply line. In the configuration of the second embodiment, there are provided a switch SW1 to select one of the three or more kinds of power supplies differing in voltage and connect it to the motor driving power supply line, and a switch SW2 to select any one of the three or more kinds of power supplies differing in voltage and connect it to the logic circuit operating power supply line. The HDD type decision section 111 determines the power supply type of the disk drive according to the value of the identification signal input via the identification signal line from the connected disk drive and switches between SW1 and SW2 according to the power supply type. The number of identification signal lines may be three or more. In the configuration of the third embodiment, the power supply unit 407 is designed to supply three or more kinds of power supplies differing in voltage corresponding to a plurality of power supply types. The CPU 401 acquires the model number from the disk drive in the initializing process and outputs a command corresponding to the model number to the HDC supply voltage control unit 405. According to the command from the CPU 401, the HDC supply voltage control unit 405 causes the power supply unit 407 to supply any one of the three or more kinds of power supplies differing in voltage to the logic circuit operating power supply line 418 and the motor driving power supply line 417.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer comprising:
a first terminal to which a motor driving voltage terminal of a disk drive can be connected;
a second terminal to which a circuit operating voltage terminal of the disk drive can be connected;
a first power line of a first voltage;
a second power line of a second voltage; and
a power supply circuit which supplies the first voltage to the first terminal and one of the first voltage and the second voltage to the second terminal.

2. A computer according to claim 1, wherein the power supply circuit comprises:
a mounting unit configured to mount a short-circuit element connecting one of the first power line and the second power line to the second terminal.

3. A computer comprising:
a first terminal to which a circuit operating voltage terminal of a disk drive can be connected;
a second terminal to which a motor driving voltage terminal of the disk drive can be connected;
a third terminal to which a motor driving voltage terminal of another disk drive can be connected;
a first power line of a first voltage;
a second power line of a second voltage; and
a power supply circuit which supplies the first voltage to the second terminal, the second voltage to the third terminal, and one of the first voltage and the second voltage to the first terminal.

4. A computer according to claim 3, wherein the power supply circuit comprises:
a first mounting unit configured to mount a short-circuit element connecting the first power line to the first terminal; and
a second mounting unit configured to mount a short-circuit element connecting the second power line to the first terminal.

5. A computer to which one of a plurality of types of disk drives differing in a circuit operating voltage and a motor driving voltage can be connected, the computer comprising:
a decision unit configured to determine the type of the disk drive connected to the computer; and
a power supply control circuit to supply the motor driving voltage and circuit operating voltage according to the type determined by the decision unit to the disk drive connected to the computer.

6. A computer to which one of a plurality of types of disk drives differing in a circuit operating voltage and a motor driving voltage can be connected, the computer comprising:
a plurality of power lines of different voltages;
a decision unit configured to determine the type of the disk drive connected to the computer based on a signal supplied from the disk drive; and
a power supply control unit configured to select a first power line which supplies a circuit operating voltage to the disk drive and a second power line which supplies a motor driving voltage to the disk drive from said plurality of power lines according to the type determined by the decision unit.

7. A computer apparatus according to claim 6, wherein the power supply control unit comprises
a first connecting unit which connects the first power line to a first terminal of the computer to supply power for circuit operation to the disk drive, and
a second connecting unit which connects the second power line to a second terminal of the computer to supply power for motor driving to the disk drive.

8. A computer apparatus according to claim 6, further comprising a connecting interface which can be connected to the disk drive and which includes a flexible cable and a connector, the flexible cable including a signal line for the disk drive to supply an identification signal to the decision unit.

9. A computer to which one of a plurality of types of disk drives differing in a circuit operating voltage and a motor driving voltage can be connected, the computer comprising:
a power supply unit configured to supply a plurality of voltages;
an acquisition unit configured to acquire identification information from the disk drive connected to the computer in an initializing process executed when a power supply is turned on; and
a voltage control unit configured to cause the power supply unit to supply a circuit operating voltage and a motor driving voltage according to the identification information acquired by the acquisition unit.

10. A computer to which one of a plurality of types of disk drives differing in a circuit operating voltage and a motor driving voltage can be connected, the computer comprising:
a power supply unit configured to supply a plurality of voltages;
a first power supply line configured to supply a motor driving voltage to the disk drive connected to the disk drive connected to the computer;
a second power supply line configured to supply a logic operating voltage to the disk drive connected to the computer;
a processing unit which, when executing an initializing process, sends a command to request identification information to the disk drive connected to the computer and outputs a select control signal corresponding to the acquired identification information; and
a control unit which selects a circuit operating voltage and a motor driving voltage from the voltages supplied by the power supply unit according to the select control signal output.

11. A method of controlling a power supply of a computer to which one of a plurality of types of disk drives differing in a circuit operating voltage and a motor driving voltage can be connected, the method comprising:
determining a type of the disk drive connected to the computer based on a signal supplied from the disk drive; and
selecting a first power line of a circuit operating voltage of the disk drive and a second power line of a motor driving voltage of the disk drive according to the determined type.

12. A method of controlling a power supply of a computer to which one of a plurality of types of disk drives differing in a circuit operating voltage and a motor driving voltage can be connected, the method comprising:
acquiring identification information from the disk drive connected to the computer in an initializing process executed when a power supply is turned on; and
causing a power supply unit supplying a plurality of voltages to supply a circuit operating voltage and a motor driving voltage according to the acquired identification information.
